(19) United States
(12) Patent Application Publication
(10) Pub. No.: US 2014/0349215 A1
(43) Pub. Date: Nov. 27, 2014

(54) ELECTROCHEMICAL CELL ELECTRODE

(71) Applicant: 3M INNOVATIVE PROPERTIES COMPANY, St. Paul, MN (US)

(72) Inventors: Mark K. Debe, Stillwater, MN (US); Amy E. Hester, Hudson, WI (US)

(73) Assignee: 3M INNOVATIVE PROPERTIES COMPANY, St. Paul, MN (US)

(21) Appl. No.: 14/368,133

(22) PCT Filed: Dec. 19, 2012
(86) PCT No.: PCT/US2012/070634

§ 371 Date: Jun. 23, 2014

Related U.S. Application Data
(60) Provisional application No. 61/581,351, filed on Dec. 29, 2011.

(51) Int. Cl. H01M 4/90; H01M 4/88; H01M 4/92

(52) U.S. Cl. CPC H01M 4/9075; H01M 4/925; H01M 4/8871
USPC 429/524; 429/523; 429/525; 429/526; 204/192.17

(57) ABSTRACT

Electrochemical cell electrode (100) comprising a nanostructured catalyst support layer (102) having first and second generally opposed major sides (103,104). The first side (103) comprises nanostructured elements (106) comprising support whiskers (108) projecting away from the first side (103). The support whiskers (108) have a first nanoscopic electrocatalyst layer (110) thereon, and a second nanoscopic electrocatalyst layer (112) on the second side (104) comprising a precious metal alloy. Electrochemical cell electrodes (100) described herein are useful, for example, as a fuel cell catalyst electrode for a fuel cell.

### CROSS REFERENCE TO RELATED APPLICATION

This application claims the benefit of U.S. Provisional Patent Application No. 61/581,351, filed Dec. 29, 2011, the disclosure of which is incorporated by reference herein in its entirety.

### BACKGROUND

Polymer electrolyte membrane (PEM) fuel cells for automotive applications need to meet rigorous performance, durability, and cost requirements. The catalyst system plays an important role in determining the cost, performance, and durability characteristics of the fuel cell. Generally, the fuel cell catalyst should utilize the catalyst mass as effectively as possible. That is, it should increase the mass specific area (m²/g) so that the ratio of surface area to mass is as high as possible, but without losing specific activity for the oxygen reduction reaction (ORR). Another functional performance characteristic for the catalyst is that the fuel cell commercially needs to have improved performance at high current densities. Yet another performance characteristic for the catalyst is that the fuel cell commercially needs to perform well at high temperatures under low humidity (i.e., above the operating cell or stack temperatures of greater than about 80° C. when the dew points of the inlet gases are less than about 60° C.), or low temperatures under high humidity (i.e., when stack temperatures are below about 50° C. and relative humidity is at or close to 100%.)

Conventional carbon supported catalysts fail to meet the rigorous performance, durability, and cost requirements of the industry. For example, the conventional carbon supported catalysts suffer from corrosion of the carbon support leading to loss of performance.

Over the last decade or so, a new type of catalyst has been developed, namely nanostructured thin film (NSTF) catalysts that overcomes many shortcomings of the conventional carbon supported catalysts. Typically, the NSTF catalyst support is an organic crystalline whisker that eliminates all aspects of the carbon corrosion plaguing conventional carbon supported catalysts. Exemplary NSTF catalysts comprise oriented Pt or Pt alloy nano-whiskers (or whiskerettes) on the organic whisker supports in the form of a catalyst coating that is a nanostructured thin film rather than a isolated nanoparticles (as is the case with conventional carbon supported catalysts), NSTF catalysts have been observed to exhibit a ten-fold higher specific activity for oxygen reduction reaction (ORR) than conventional carbon supported catalysts. The ORR is typically the performance limiting reaction during the operation of a fuel cell reaction. The thin film morphology of the NSTF catalyst has been observed to exhibit improved resistance to Pt corrosion under high voltage excursions while producing much lower levels of peroxides that lead to premature membrane failure.

There is a need in the industry for fuel cell catalyst with even further improved performance, for example, with high surface area and specific activity at reduced loadings (<0.15 mg-Pt/cm² total).

### SUMMARY

In one aspect, the present disclosure describes an electrochemical cell electrode comprising a nanostructured catalyst support layer having first and second generally opposed major sides, wherein the first side comprises nanostructured elements comprising support whiskers projecting away from the first side, the support whiskers having a first nanoscopic electrocatalyst layer thereon, and a second nanoscopic electrocatalyst layer on the second side comprising a precious metal alloy comprising e.g., at least one of Pt, Ir, Au, Os, Re, Pd, Rh, or Ru (in some embodiments, at least one of Pt, Ir, or Ru)). The precious metal alloy composition is chosen to be effective for at least one of oxygen reduction or oxygen evolution.

In some embodiments, the precious metal alloy on the second major surface also comprises at least one transition metal (e.g., at least one of Ni, Co, Ti, Mn, or Fe).

Typically both the nanostructured elements and the second side having the second nanoscopic electrocatalyst layer thereon both comprise a first material (e.g., perylene red; typically for the nanoscopic electrocatalyst layer unconverted perylene red). Unconverted perylene red refers to material that takes a form in-between the structure of the as-deposited material phase on the one hand, and the structure of the crystalline whisker phase on the other hand.

In another aspect, the present disclosure describes a method of making an electrochemical cell electrode described herein, the method comprising:

providing a nanostructured catalyst support layer having first and second generally opposed major sides, wherein the first side comprises nanostructured elements comprising support whiskers projecting away from the first side, the support whiskers having a first nanoscopic electrocatalyst layer thereon; and

sputtering a precious metal alloy (comprising e.g., at least one of Pt, Ir, Au, Os, Re, Pd, Rh, or Ru (in some embodiments, at least one of Pt, Ir, or Ru)) onto the second side to provide a second nanoscopic electrocatalyst layer thereon. In some embodiments, the precious metal alloy sputtered onto the second major surface also comprises at least one transition metal (e.g., at least one of Ni, Co, Ti, Mn, or Fe). Typically both the nanostructured elements and the second side having the second nanoscopic electrocatalyst layer thereon both comprise a first material (e.g., perylene red; typically for the nanoscopic electrocatalyst layer unconverted perylene red). Unconverted perylene red refers to the material that takes a form in-between the structure of the as-deposited material phase on the one hand, and the structure of the crystalline whisker phase on the other hand as the latter phase is formed by the annealing process step.

Electrochemical cell electrodes described herein are useful, for example, as anode or cathode electrodes for a fuel cell, an electrolyzer or a flow battery. Surprisingly, improved high current density performance and kinetic metrics for oxygen reduction have been observed in embodiments of electrochemical cell electrodes described herein in a cathode electrode construction with a H₂/air proton exchange membrane fuel cell MEA (membrane electrode assembly).

### BRIEF DESCRIPTION OF THE DRAWINGS

FIG. 1 is a schematic of an exemplary electrochemical cell electrode described herein.

FIG. 2 is a schematic of an exemplary fuel cell.

FIG. 3A, FIG. 3B, and FIG. 3C are SEM digital photomicrographs of cross sections of nanostructured catalyst supports after depositing and annealing for initial organic pigment material (“PR149”) deposition thicknesses of 2400 Angstroms, 3600 Angstroms, and 7200 Angstroms, respectively.

FIG. 4 is the potentiodynamic curves (PDS) for Examples 1-7 and Comparative Examples A-D.

FIG. 5 is the galvanodynamic curves (GDS) for Examples 1-7 and Comparative Examples A-D.

FIG. 6 is the galvanodynamic cell voltage response as a function of relative humidity at 90° C. for Examples 1-7 and Comparative Examples A-D.

### DETAILED DESCRIPTION

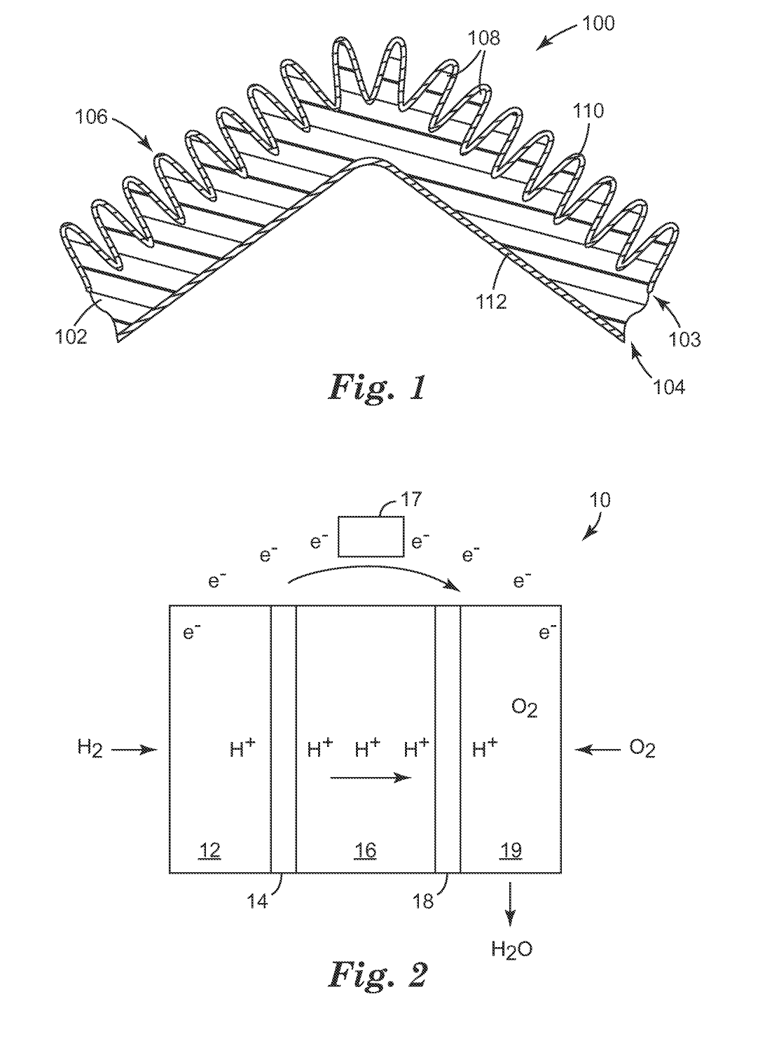

Exemplary electrochemical cell electrode 100 is shown in FIG. 1. Electrochemical cell electrode 100 comprises nanostructured catalyst support layer 102 having first and second generally opposed major sides 103, 104. First side 103 comprises nanostructured elements 106 comprising support whiskers 108 projecting away from the first side 103. Support whiskers 108 have first nanoscopic electrocatalyst layer 110 thereon, and second nanoscopic electrocatalyst layer 112 on second side 104. Second nanoscopic electrocatalyst layer 112 comprises precious metal alloy.

Support whiskers can be provided by techniques known in the art, including those described in U.S. Pat. No. 4,812,352 (Debe), U.S. Pat. No. 5,039,561 (Debe), U.S. Pat. No. 5,338,430 (Parsonage et al.), U.S. Pat. No. 6,136,412 (Spiewak et al.), and U.S. Pat. No. 7,419,741 (Verstrom et al.), the disclosures of which are incorporated herein by reference. In general, the support whiskers are nanostructured whiskers that can be provided, for example, by vacuum depositing (e.g., by sublimation) a layer of organic or inorganic material, onto a substrate (e.g., a microstructured catalyst transfer polymer), and then converting the material into nanostructured whiskers by thermal annealing. Typically the vacuum deposition steps are carried out at total pressures at or below about 10⁻³ Torr or 0.1 Pascal. Exemplary microstructures are made by thermal sublimation and vacuum annealing of the organic pigment C.I. Pigment Red 149 (i.e., N,N′-di(3,5-xylyl)perylene-3,4:9,10-bis(dicarboximide)). Methods for making organic nanostructured layers are disclosed, for example, in Materials Science and Engineering, A158 (1992), pp. 1-6; J. Vac. Sci. Technol. A, 5 (4), July/August, 1987, pp. 1914-16; J. Vac. Sci. Technol. A, 6, (3), May/August, 1988, pp. 1907-11; Thin Solid Films, 186, 1990, pp. 327-47; J. Mat. Sci., 25, 1990, pp. 5257-68; Rapidly Quenched Metals, Proc. of the Fifth Int. Conf. on Rapidly Quenched Metals, Wurzburg, Germany (Sep. 3-7, 1984), S. Steeb et al., eds., Elsevier Science Publishers B.V., New York, (1985), pp. 1117-24; Photo. Sci. and Eng., 24, (4), July/August, 1980, pp. 211-16; and U.S. Pat. No. 4,340,276 (Maffitt et al.) and U.S. Pat. No. 4,568,598 (Bilkadi et al.), the disclosures of which are incorporated herein by reference. Properties of catalyst layers using carbon nanotube arrays are disclosed in the article “High Dispersion and Electrocatalytic Properties of Platinum on Well-Aligned Carbon Nanotube Arrays,” Carbon 42 (2004) 191-197. Properties of catalyst layers using grassy or bristled silicon are disclosed in U.S. Pat. App. Pub. 2004/0048466 A1 (Gore et al.).

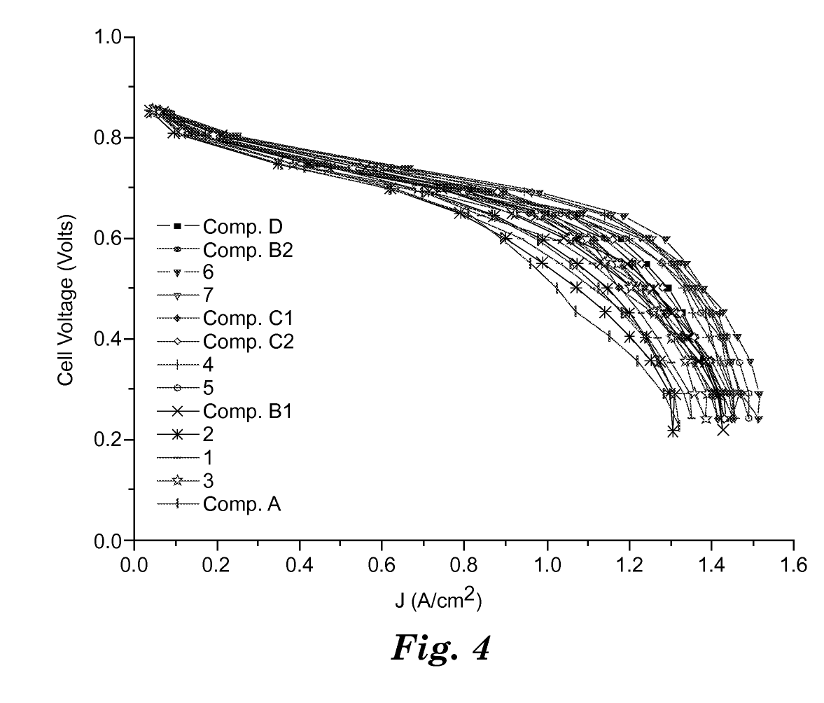

Vacuum deposition may be carried out in any suitable apparatus (see, e.g., U.S. Pats. No. 5,338,430 (Parsonage et al.), U.S. Pat. No. 5,879,827 (Debe et al.), U.S. Pat. No. 5,879,828 (Debe et al.), U.S. Pat. No. 6,040,077 (Debe et al.), and U.S. Pat. No. 6,319,293 (Debe et al.), and U.S. Pat. App. Pub. No. 2002/0004453 A1 (Haugen et al.), the disclosures of which are incorporated herein by reference. One exemplary apparatus is depicted schematically in FIG. 4A of U.S. Pat. No. 5,338,430 (Parsonage et al.), and discussed in the accompanying text, wherein the substrate is mounted on a drum which is then rotated over a sublimation or evaporation source for depositing the organic precursor (e.g., perylene red pigment) to the nanostructured whiskers.

Typically, the nominal thickness of deposited perylene red pigment is in a range from about 50 nm to 800 nm. Typically, the whiskers have an average cross-sectional dimension in a range from 20 nm to 60 nm and an average length in a range from 0.3 micrometer to 3 micrometers.

In some embodiments, the whiskers are attached to a backing. Exemplary backings comprise polyimide, nylon, metal foils, or other material that can withstand the thermal annealing temperature up to 300° C. for the perylene red, or whatever the maximum temperature required to generate the support nanostructures by other methods described.

In some embodiments, the first material on the second side has a thickness in a range from 10 nm to 200 nm (in some embodiments, 25 nm to 175 nm).

In some embodiments, the backing has an average thickness in a range from 25 micrometers to 125 micrometers.

In some embodiments, the backing has a microstructure on at least one of its surfaces. In some embodiments, the microstructure is comprised of substantially uniformly shaped and sized features at least three (in some embodiments, at least four, five, ten or more) times the average size of the nanostructured whiskers. The shapes of the microstructures can, for example, be V-shaped grooves and peaks (see, e.g., U.S. Pat. No. 6,136,412 (Spiewak et al.), the disclosure of which is incorporated herein by reference) or pyramids (see, e.g., U.S. Pat. No. 7,901,829 (Debe et al.), the disclosure of which is incorporated herein by reference). In some embodiments some fraction of the features of the microstructures extend above the average or majority of the microstructured peaks in a periodic fashion, such as every 31^{st} V-groove peak is 25% or 50% or even 100% taller than those on either side of it. In some embodiments, this fraction of features that extend above the majority of the microstructured peaks can be up to 10% (in some embodiments up to 3%, 2%, or even up to 1%). Use of the occasional taller microstructure features may facilitate protecting the uniformly smaller microstructure peaks when the coated substrate moves over the surfaces of rollers in a roll-to-roll coating operation. The occasional taller feature touches the surface of the roller rather than the peaks of the smaller microstructures and so much less of the nanostructured material or whiskers is likely to be scraped or otherwise disturbed as the substrate moves through the coating process. In some embodiments, the microstructure features are substantially smaller than half the thickness of the membrane that the catalyst will be transferred to in making a membrane electrode assembly (MEA). This is so that during the catalyst transfer process, the taller microstructure features do not penetrate through the membrane where they may overlap the electrode on the opposite side of the membrane. In some embodiments, the tallest microstructure features are less than ⅓^{th} or ¼^{th} of the membrane thickness. For the thinnest ion exchange membranes (e.g., about 10 to 15 micrometers in thickness), it may be desirable to have a substrate with microstructured features no larger than about 3 to 4.5 micrometers tall. The steepness of the sides of the V-shaped or other microstructured features or the included angles between adjacent features may in some embodiments be desirable to be on the order of 90° for ease in catalyst transfer during a lamination-transfer process and have a gain in surface area of the electrode that comes from the square root of two (1.414) surface area of the microstructured layer relative to the planar geometric surface of the substrate backing.

In some embodiments, the first nanoscopic electrocatalyst layer is directly coated onto the nanostructured whiskers, while in others there may be an intermediate (typically conformal) layer(s) such as a functional layer imparting desirable catalytic properties, and may also impart electrical conductivity and mechanical properties (e.g., strengthens and/or protects the nanostructures comprising the nanostructured layer), and low vapor pressure properties. The intermediate layer may also provide nucleation sites which influence the way the subsequent alternating layers deposit and develop a crystalline morphology.

In some embodiments, an intermediate layer comprises an inorganic material or organic material including a polymeric material. Exemplary organic materials include conductive polymers (e.g., polyacetylene), polymers derived from poly-p-xylylene, and materials capable of forming self-assembled layers. Typically the thickness of an intermediate layer is in a range from about 0.2 to about 50 nm. An intermediate layer may be deposited onto the nanostructured whiskers using conventional techniques, including, those disclosed in U.S. Pat. No. 4,812,352 (Debe) and U.S. Pat. No. 5,039,561 (Debe), the disclosures of which are incorporated herein by reference. Typically it is desirable that any method used to provide an intermediate layers(s) avoid disturbance of the nanostructured whiskers by mechanical forces. Exemplary methods include vapor phase deposition (e.g., vacuum evaporation, sputtering (including ion sputtering), cathodic arc deposition, vapor condensation, vacuum sublimation, physical vapor transport, chemical vapor transport, metalorganic chemical vapor deposition, atomic layer deposition, and ion beam assisted deposition,) solution coating or dispersion coating (e.g., dip coating, spray coating, spin coating, pour coating (i.e., pouring a liquid over a surface and allowing the liquid to flow over the nanostructured whiskers, followed by solvent removal)), immersion coating (i.e., immersing the nanostructured whiskers in a solution for a time sufficient to allow the layer to adsorb molecules from the solution, or colloid or other dispersed particles from a dispersion), and electrodeposition including electroplating and electroless plating. In some embodiments, the intermediate layer is a catalytic metal, metal alloy, oxide or nitride thereof. Additional details can be found, for example, in U.S. Pat. No. 7,790,304 (Hendricks et al.), the disclosure of which is incorporated herein by reference.

In general, the electrocatalyst layers can be deposited onto the applicable surface by any of the exemplary methods described herein, including chemical (CVD) and physical vapor deposition PVD) methods as described, for example, in U.S. Pat. No. 5,879,827 (Debe et al.), U.S. Pat. No. 6,040,077 (Debe et al.), and. U.S. Pat. No. 7,419,741 (Vernstrom et al.), the disclosures of which are incorporated herein by reference. Exemplary PVD methods include magnetron sputter deposition, plasma deposition, evaporation, and sublimation deposition.

In some embodiments, the first electrocatalyst layer comprises at least one of a precious metal (e.g., at least one of Pt, Ir, Au, Os, Re, Pd, Rh, or Ru), non-precious metal (e.g., at least one of transition metal (e.g., Ni, Co, and Fe), or alloy thereof. The first electrocatalyst layer is typically provided by sputtering. One exemplary platinum alloy, platinum-nickel, and methods for depositing the same, are described, for example in PCT Pat. Appl. No. US2011/033949, filed Apr. 26, 2011, the disclosure of which is incorporated herein by reference. Exemplary platinum nickel alloys include Pt₁₋ₓNiₓ where x is in the range of 0.5 to 0.8 by atomic. Exemplary ternary precious metals, and methods for depositing the same, are described, for example in U.S. Pat. Pub. No. 2007-0082814, filed Oct. 12, 2005, the disclosure of which is incorporated herein by reference. Optionally, the first electrocatalyst layer may comprise multiple layers of precious metals, non-precious metals, and combinations thereof. Exemplary multiple layers methods for depositing the same, are described, for example in U.S. Pat. Appl. No. 61/545,409, filed Oct. 11, 2011, the disclosure of which is incorporated herein by reference. Electrocatalysts with good activity for the oxygen evolution reaction include those comprising Pt, Ir, and Ru.

In some embodiments, the precious metal alloy of the second electrocatalyst layer comprises, for example, at least one of Pt, Ir, Au, Os, Re, Pd, Rh, or Ru (in some embodiments, at least one of Pt, Ir, or Ru)). In some embodiments, the precious metal alloy on the second major surface also comprises at least one transition metal (e.g., at least one of Ni, Co, Ti, Mn, or Fe).

The second electrocatalyst layer can be provided by the techniques referred to above for providing the first electrocatalyst layer, including physical vapor deposition by magnetron sputter-deposition.

In some embodiments, the first and second electrocatalyst layers are the same material (i.e., they have the same composition), while in others they are different. In some embodiments, the precious metal alloy of the on the second major surface comprises Pt and at least one other, different metal (e.g., at least one of Ni, Co, Ti, Mn, or Fe). In some embodiments, the atomic percent of platinum to the sum of all other metals in the precious metal alloy on the second major surface is in a range from 1:20 (0.05) to 95:100 (0.95).

In some embodiments, the first and second nanoscopic electrocatalyst layers independently have an average planar equivalent thickness in a range from 0.1 nm to 50 nm. “Planar equivalent thickness” means, in regard to a layer distributed on a surface, which may be distributed unevenly, and which surface may be an uneven surface (such as a layer of snow distributed across a landscape, or a layer of atoms distributed in a process of vacuum deposition), a thickness calculated on the assumption that the total mass of the layer was spread evenly over a plane covering the same projected area as the surface (noting that the projected area covered by the surface is less than or equal to the total surface area of the surface, once uneven features and convolutions are ignored).

In some embodiments, the first and second nanoscopic electrocatalyst layers independently comprise up to 0.5 mg/cm² (in some embodiments, up to 0.25, or even up to 0.1 mg/cm²) catalytic metal. In some embodiments, the nanoscopic electrocatalyst layer comprises 0.15 mg/cm² of Pt, distributed with 0.05 mg/cm² of Pt on the anode and 0.10 mg/cm² of Pt on the cathode.

Optionally, at least one of the first and second nanoscopic electrocatalyst layers can be annealed as described, for example, in PCT Pub. No. 2011/139705, published Nov. 10, 2011, the disclosure of which is incorporated herein by reference. An exemplary method for annealing is via scanning laser.

In some embodiments, electrochemical cell electrodes described herein having Pt on both the first and second sides have a first Pt surface area on the first side greater than zero, wherein the first and second nanoscopic electrocatalyst layers each comprise Pt and have a collective Pt content, wherein the collective Pt content if just present just on the first side would have a second Pt surface area greater than zero, and wherein the Pt first surface area is at least 10 (in some embodiments, at least 15, 20, or even 25) percent greater than the second Pt surface area.

In some embodiments, electrochemical cell electrodes described herein having Pt on both the first and second sides each comprise Pt and have a first Pt specific activity on the first side greater than zero, wherein the first and second nanoscopic electrocatalyst layers have a collective Pt content, wherein the collective Pt content if just present on the first side would have a second Pt specific activity greater than zero, and wherein the Pt first specific activity is at least 10 (in some embodiments, at least 15, 20, or even 25) percent greater than the second Pt specific activity.

In some embodiments, electrochemical cell electrodes described herein having Pt on both the first and second sides, wherein the first nanoscopic electrocatalyst layer has a first absolute activity greater than zero, wherein the second nanoscopic electrocatalyst layer has a second absolute activity greater than zero, and wherein the first absolute activity is at least 10 (in some embodiments, at least 15, 20, or even 25) percent greater than the second absolute activity.

In some embodiments, electrochemical cell electrodes described herein having Pt on both the first and second sides, wherein the first nanoscopic electrocatalyst layer has a first Pt content greater than zero and a first Pt surface area greater than zero, wherein the second nanoscopic electrocatalyst layer has a second Pt content and a second Pt surface area greater than zero, wherein the sum of the first and second Pt surface areas is at least 10 (in some embodiments, at least 15, 20, or even 25) percent greater than the second Pt surface area.

In some embodiments, electrochemical cell electrodes described herein having Pt on both the first and second sides, wherein the first nanoscopic electrocatalyst layer has a first Pt content greater than zero and a first Pt specific activity greater than zero, wherein the second nanoscopic electrocatalyst layer has a second Pt content and a second Pt specific activity greater than zero, wherein the sum of the first and second Pt specific activities is at least 10 (in some embodiments, at least 15, 20, or even 25) percent greater than the second Pt specific activity.

Electrochemical cell electrodes described herein are useful, for example, as anode or cathode electrodes for a fuel cell, an electrolyzer or a flow battery.

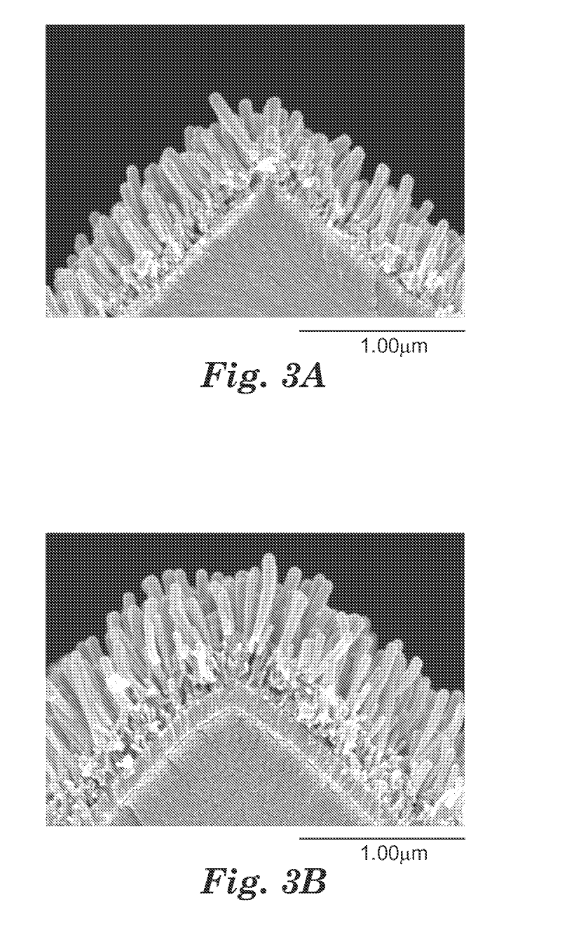

An exemplary fuel cell is depicted in FIG. 2. Cell 10 shown in FIG. 2 includes first fluid transport layer (FTL) 12 adjacent anode 14. Adjacent anode 14 is electrolyte membrane 16. Cathode 18 is situated adjacent electrolyte membrane 16, and second fluid transport layer 19 is situated adjacent cathode 18. FTLs 12 and 19 can be referred to as diffuser/current collectors (DCCs) or gas diffusion layers (GDLs). In operation, hydrogen is introduced into anode portion of cell 10, passing through first fluid transport layer 12 and over anode 14. At anode 14, the hydrogen fuel is separated into hydrogen ions (H⁺) and electrons (e).

Electrolyte membrane 16 permits only the hydrogen ions or protons to pass through electrolyte membrane 16 to the cathode portion of fuel cell 10. The electrons cannot pass through electrolyte membrane 16 and, instead flow thorough an external electrical circuit in the form of electric current. This current can power electric load 17 such as an electric motor or be directed to an energy storage device, such as a rechargeable battery.

The catalyst electrodes described herein are used to manufacture catalyst coated membranes (CCM's) or membrane electrode assemblies (MEA's) incorporated in fuel cells such as are described in U.S. Pat. No. 5,879,827 (Debe et al.) and U.S. Pat. No. 5,879,828 (Debe et al.), the disclosures of which are incorporated herein by reference.

MEAs may be used in fuel cells. An MEA is the central element of a proton exchange membrane fuel cell, such as a hydrogen fuel cell. Fuel cells are electrochemical cells which produce usable electricity by the catalyzed electrochemical oxidation of a fuel such as hydrogen and reduction of an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts, typically including platinum metal. The PEM forms a durable, non-porous, electrically non-conductive mechanical barrier between the reactant gases, yet it also passes H⁺ ions and water readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's and the resulting catalyst-coated GDL's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA.

A PEM used in a CCM or MEA described herein may comprise any suitable polymer electrolyte. Exemplary useful polymer electrolytes typically bear anionic functional groups bound to a common backbone, which are typically sulfonic acid groups but may also include carboxylic acid groups, imide groups, amide groups, or other acidic functional groups. Exemplary useful polymer electrolytes are typically highly fluorinated and most typically perfluorinated. Exemplary useful electrolytes include copolymers of tetrafluoroethylene and at least one fluorinated, acid-functional comonomers. Typical polymer electrolytes include those available from DuPont Chemicals, Wilmington Del., under the trade designation “NAFION” and from Asahi Glass Co. Ltd., Tokyo, Japan, under the trade designation “FLEMION”. The polymer electrolyte may be a copolymer of tetrafluoroethylene (TFE) and FSO₂—CF₂CF₂CF₂CF₂—O—CF=CF₂, described in U.S. Pat. No. 6,624,328 (Guerra) and U.S. Pat. No. 7,348,088 (Hamrock et al.) and U.S. Pub No. US2004/0116742 (Guerra), the disclosures of which are incorporated herein by reference. The polymer typically has an equivalent weight (EW) up to 1200 (in some embodiments, up to 1100, 1000, 900, 800, 700, or even up to 600).

The polymer can be formed into a membrane by any suitable method. The polymer is typically cast from a suspension. Any suitable casting method may be used, including bar coating, spray coating, slit coating, and brush coating. Alternately, the membrane may be formed from neat polymer in a melt process such as extrusion. After forming, the membrane may be annealed, typically at a temperature of at least 120° C. (in some embodiments, at least 130° C., 150 C, or higher). The membrane typically has a thickness up to 50 micrometers (in some embodiments, up to 40 micrometers, 30 micrometers, 15 micrometers, 20 micrometers, or even up to 15 micrometers.

In making an MEA, GDL's may be applied to either side of a CCM. The GDL's may be applied by any suitable means. Suitable GDLs include those stable at the electrode potentials of use. Typically, the cathode GDL is a carbon fiber construction of woven or non-woven carbon fiber constructions. Exemplary carbon fiber constructions include those available, for example, under the trade designation “TORAY” (carbon paper) from Toray, Japan; “SPECTRACARB” (carbon paper) from Spectracorb, Lawrence, Mass.; and “ZOLTEK” (Carbon Cloth) from St. Louis, Mo., as well as from Mitibushi Rayon Co, Japan; Freudenberg, Germany; and Ballard, Vancouver, Canada. The GDL may be coated or impregnated with various materials, including carbon particle coatings, hydrophilizing treatments, and hydrophobizing treatments such as coating with polytetrafluoroethylene (PTFE).

In use, MEAs described herein are typically sandwiched between two rigid plates, known as distribution plates, also known as bipolar plates (BPP's) or monopolar plates. Like the GDL, the distribution plate must be electrically conductive and be stable at the potentials of the electrode GDL against which it is place. The distribution plate is typically made of materials such as carbon composite, metal, or plated metals. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing air or oxygen to the cathode of the first MEA while the other face directs hydrogen to the anode of the next MEA, hence the term “bipolar plate.” In stack configuration, the bi-polar plate often has interior channels for carrying a coolant fluid to remove excess heat generated by the electrochemical processes on the electrodes of its adjoining MEA's. Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates.

### Exemplary Embodiments

1. An electrochemical cell electrode comprising a nanostructured catalyst support layer having first and second generally opposed major sides, wherein the first side comprises nanostructured elements comprising support whiskers projecting away from the first side, the support whiskers having a first nanoscopic electrocatalyst layer thereon, and the a second nanoscopic electrocatalyst layer on the second side comprising precious metal alloy.
2. The electrochemical cell electrode of Embodiment 1, wherein the precious metal of the second nanoscopic electrocatalyst layer is at least one of Pt, Ir, Au, Os, Re, Pd, Rh, or Ru (in some embodiments, at least one of Pt, Ir, or Ru).
3. The electrochemical cell electrode of either Embodiment 1 or 2, wherein the precious metal alloy on the second major surface comprises at least one metal transition metal.
4. The electrochemical cell electrode of either Embodiment 1 or 2, wherein the precious metal alloy on the second major surface comprises at least one of Ni, Co, Ti, Mn, or Fe.
5. The electrochemical cell electrode of Embodiment 1, wherein the precious metal alloy on the second major surface comprises Pt and at least one other, different metal
6. The electrochemical cell electrode of Embodiment 5, wherein the atomic percent of platinum to the sum of all other metals in the precious metal alloy on the second major surface is in a range from 1:20 to 95:100.
7. The electrochemical cell electrode of any preceding Embodiment, wherein the first electrocatalyst layer comprises at least one of a precious metal or alloy thereof.
8. The electrochemical cell electrode of Embodiment 7, wherein the precious metal of the first electrocatalyst layer is at least one of Pt, Ir, Au, Os, Re, Pd, Rh, or Ru.
9. The electrochemical cell electrode of any preceding Embodiment, wherein the first and second electrocatalyst layers are the same material.
10. The electrochemical cell electrode of any of Embodiments 1 to 8, wherein the first and second electrocatalyst layers are different materials.
11. The electrochemical cell electrode of any preceding Embodiment, wherein the support layer has an average thickness in a range from 0.3 micrometer to 2 micrometer.
12. The electrochemical cell electrode of any preceding Embodiment, wherein the whiskers have an average cross-sectional dimension in a range from 20 nm to 60 nm and an average length in a range from 0.3 micrometer to 3 micrometers.
13. The electrochemical cell electrode of any preceding Embodiment, wherein the first and second nanoscopic electrocatalyst layers independently have an average planar equivalent thickness in a range from 0.1 nm to 50 nm.
14. The electrochemical cell electrode of any preceding Embodiment, wherein the whiskers comprise perylene red.
15. The electrochemical cell electrode of any of Embodiments 1 to 13, wherein the nanostructured elements comprising a first material, and wherein the second side having the second nanoscopic electrocatalyst layer thereon also comprises the first material.
16. The electrochemical cell electrode of any preceding Embodiment, the first material is perylene red.
17. The electrochemical cell electrode of Embodiment 16, wherein the perylene red on the second side is unconverted perylene red.
18. The electrochemical cell electrode of any of Embodiments 15 to 17, wherein the first material on the second side has a thickness in a range from 10 nm to 200 nm (in some embodiments, 25 nm to 175 nm).
19. The electrochemical cell electrode of any of Embodiments 15 to 18 having a first Pt surface area on the first side greater than zero, wherein the first and second nanoscopic electrocatalyst layers each comprise Pt and have a collective Pt content, wherein the collective Pt content if present just on the first side would have a second Pt surface area greater than zero, and wherein the Pt first surface area is at least 10 (in some embodiments, at least 15, 20, or even 25) percent greater than the second Pt surface area.
20. The electrochemical cell electrode of any of Embodiments 15 to 19 having a first Pt specific activity on the first side greater than zero, wherein the first and second nanoscopic electrocatalyst layers each comprise Pt and have a collective Pt content, wherein the collective Pt content if just present on the first side would have a second Pt specific activity greater than zero, and wherein the Pt first specific activity is at least 10 (in some embodiments, at least 15, 20, or even 25) percent greater than the second Pt specific activity.
21. The electrochemical cell electrode of any of Embodiments 15 to 20, wherein the first nanoscopic electrocatalyst layer has a first absolute activity greater than zero, wherein the second nanoscopic electrocatalyst layer has a second absolute activity greater than zero, and wherein the first absolute activity is at least 10 (in some embodiments, at least 15, 20, or even 25) percent greater than the second absolute activity.
22. The electrochemical cell electrode of any of Embodiments 15 to 18, wherein the first nanoscopic electrocatalyst layer has a first Pt content greater than zero and a first Pt surface area greater than zero, wherein the second nanoscopic electrocatalyst layer has a second Pt content and a second Pt surface area greater than zero, wherein the sum of the first and second Pt surface areas is at least 10 (in some embodiments, at least 15, 20, or even 25) percent greater than the second Pt surface area.
23. The electrochemical cell electrode of any of Embodiments 15 to 18 or 22, wherein the first nanoscopic electrocatalyst layer has a first Pt content greater than zero and a first Pt specific activity greater than zero, wherein the second nanoscopic electrocatalyst layer has a second Pt content and a second Pt specific activity greater than zero, wherein the sum of the first and second Pt specific activities is at least 10 (in some embodiments, at least 15, 20, or even 25) percent greater than the second Pt specific activity.
24. The electrochemical cell electrode of any preceding Embodiment that is a fuel cell catalyst electrode.
25. The electrochemical cell electrode of Embodiment 24, wherein the catalyst is an anode catalyst.
26. The electrochemical cell electrode of Embodiment 24, wherein the catalyst is a cathode catalyst.
27. A method of making an electrochemical cell electrode of any preceding Embodiment, the method comprising:

providing a nanostructured catalyst support layer having first and second generally opposed major sides, wherein the first side comprises nanostructured elements comprising support whiskers projecting away from the first side, the support whiskers having a first nanoscopic electrocatalyst layer thereon; and

sputtering a precious metal alloy onto the second side to provide a second nanoscopic electrocatalyst layer thereon.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### General Method for Preparing Nanostructured Catalyst Support

A roll-good web of as obtained polyimide film (obtained from E.I. du Pont de Nemours, Wilmington, Del. under trade designation “KAPTON”) was used as the substrate on which pigment material (C.I. Pigment Red 149, also known as “PR149”, obtained from Clariant, Charlotte, N.C.) was deposited. The major surfaces of the polyimide film had V-shaped features with about 3 micrometers tall peaks, spaced 6 micrometers apart. This substrate is referred to as microstructured catalyst transfer substrate (MCTS).

A nominally 100 nm thick layer of Cr was sputter deposited onto the major surface of the polyimide film using a DC magnetron planar sputtering target and typical background pressures of Ar and target powers known to those skilled in the art sufficient to deposit the Cr in a single pass of the polyimide film web under the target at the desired web speed. The Cr coated polyimide film web then passed over a sublimation source containing the pigment material (“PR149”). The pigment material (“PR149”) was heated to a controlled temperature of about 500° C. so as to generate sufficient vapor pressure flux to deposit in a single pass the desired amount (e.g., 0.022 mg/cm²) (about a 220 nm thick layer) of pigment material (“PR149”). The thickness of the pigment material (“PR149”) on the web was controlled by varying either the temperature of the sublimation source or the web speed. The mass or thickness deposition rate of the sublimation can be measured in any suitable fashion known to those skilled in the art, including optical methods sensitive to film thickness, or quartz crystal oscillator devices sensitive to mass.

The pigment material (“PR149”) coating was then converted to a nanostructured thin film (comprising whiskers) by thermal annealing, as described in U.S. Pat. No. 5,039,561 (Debe), and U.S. Pat. No. 4,812,352 (Debe), the disclosures of which are incorporated herein by reference, by passing the pigment material (“PR149”) coated web through a vacuum having a temperature distribution sufficient to convert the pigment material (“PR149”) as-deposited layer into a nanostructured thin film (NSTF) comprising oriented crystalline whiskers at a desired web speed, such that the NSTF layer had an average whisker areal number density of 68 whiskers per square micrometer, as determined from scanning electron microscopy (SEM) with an average length of 0.6 micrometer. The pigment material (“PR149”) thicknesses varied, as is specified in the particular Examples below. All samples were passed through the annealing stage at the same web-speed.

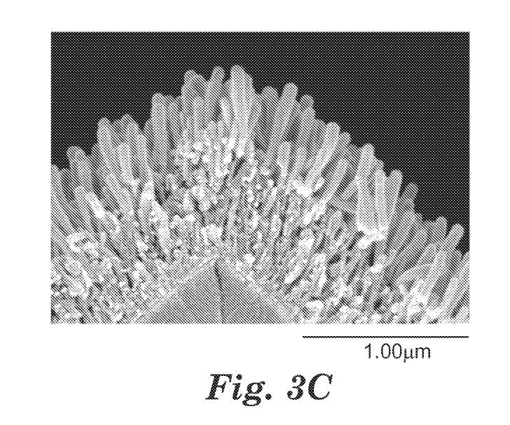

FIGS. 3A-3C show SEM cross-sectional images of the various NSTF whiskers as grown on the MCTS after annealing initial pigment material (“PR149”) layer of thickness of 2400 Angstroms, 3600 Angstroms, and 7200 Angstroms, respectively. The starting thicknesses of the pigment material (“PR149”) that was converted by thermal annealing into the oriented crystalline whiskers are shown and also listed in the respective examples below. FIGS. 3A-3C also show the remaining unconverted portions of pigment material (“PR149”) layer after the annealing. All samples were annealed at the same speed of 5 ft/min. (1.5 meters/min.) through the annealing oven set at the same temperature.

In FIGS. 3A-3C, the porous layer of remaining pigment material (“PR149”) consists of pre-formed or non-converted perylene. For a given annealing time (web speed through the oven) the thickness of this non-converted layer increased as the amount of starting pigment material (“PR149”) layer increased.

### General Method for Coating Nanoscopic Catalyst Layers on Nanostructured Catalyst Support Whiskers (Nanostructured Thin Film (NSTF))

Nanostructured thin film (NSTF) catalyst layers were prepared by sputter coating catalyst films onto the NSTF whiskers (prepared as described above). More specifically, PtCoMn ternary alloys were magnetron sputter deposited onto the NSTF substrates prepared as above, using typical Ar sputter gas pressures of about SmTorr (0.66 Pa), and 5 inch×15 inch (12.7 centimeter×38.1 centimeter) rectangular sputter targets.

For all examples, the same amount of Pt containing catalyst (i.e., 0.10 mg-Pt/cm² of the PtCoMn ternary having the nominal composition of Pt₆₈Co₂₉Mn₃ in atomic percents) was deposited onto the NSTF whiskers prior to their transfer to the membrane to make a Catalyst Coated Membrane (CCM), as described below. The catalysts were deposited onto the NSTF whiskers in multiple passes under Pt and CoMn single targets, to deposit a combined bi-layer of desired thickness. The DC magnetron sputtering target deposition rates were measured by standard methods known to those skilled in the art. Each magnetron sputtering target power was controlled to give the desired deposition rate of that element at the operating web speed sufficient to give the desired bi-layer thickness of catalysts on the NSTF substrates for each pass past the targets. Bi-layer thicknesses refer to the planar equivalent thickness of the deposited material, as-measured if the same deposition rate and time were used to deposit the films on a perfectly flat surface assuming that the coating was spread over the surface evenly. Typical bi-layer thicknesses (total planar equivalent thickness of a first layer and the next occurring second layer) were less than or about 50 Angstroms. The number of passes was then chosen to give the total desired loading of Pt.

In FIG. 3, the porous layer of remaining pigment material (“PR149”) consists of pre-formed or non-converted perylene. For a given annealing time (web speed through the oven) the thickness of this non-converted layer increased as the amount of starting pigment material (“PR149”) layer increased. When transferred to a membrane, this porous non-converted layer was on top of the CCM catalyst electrode. For the examples according to the invention, described below, this non converted layer was coated with a second nanoscopic catalyst layer while for comparative examples described below, no second nanoscopic catalyst was applied on this non converted layer.

General Method for Preparing Catalyst Coated Membrane (CCM) for Subsequent Coating and Fuel Cell Testing Per this Invention

Catalyst-coated-membranes (CCM's) were made by simultaneously transferring the catalyst coated NSTF whiskers described above onto both surfaces (full CCM) of a proton exchange membrane

(PEM) using the processes as described in detail in U.S. Pat. No. 5,879,827 (Debe et al.), one surface forming the anode side and the opposing surface forming the cathode side of the CCM. The catalyst transfer was accomplished by hot roll lamination onto a perfluorinated sulfonic acid membrane made by and commercially available from 3M Company, St. Paul, Minn. with a nominal equivalent weight of 850 and thickness of 20 micrometers. The hot roll temperatures were 350° F. (177° C.) and the gas line pressure fed to 3 inch (7.62 cm) diameter hydraulic cylinders that forced the laminator rolls together at the nip ranged from 150 to 180 psi (1.03 MPa-1.24 MPa). The NSTF catalyst coated MCTS was precut into 13.5 cm×13.5 cm square shapes and sandwiched onto one or both side(s) of a larger square of the PEM. The PEM with catalyst coated MCTS on one or both side(s) of it were placed between 2 mil (50 micrometer) thick polyimide film and then coated with paper on the outside prior to passing the stacked assembly through the nip of the hot roll laminator at a speed of 1.2 ft/min. (37 cm/min). Immediately after passing through the nip, while the assembly was still warm, the layers of polyimide and paper were quickly removed and the Cr-coated MCTS substrates from the cathode catalyst side were peeled off the CCM by hand, leaving the first nanoscopic electrocatalyst coated whisker support layer attached to the PEM surface and the whole CCM still attached to the anode side MCTS. This exposed the non-converted ends of whisker support films on the outside surface of the cathode side of the CCM. This so-formed CCM was then mounted in a vacuum chamber and additional catalyst was sputtered onto the exposed outer surface of the CCM to produce the second nanoscopic electrocatalyst layer of the cathode electrode, as described more fully in the specific examples below. The vacuum chamber used is depicted schematically in FIG. 4A of U.S. Pat. No. 5,879,827 (Debe et al.), the disclosure of which is incorporated herein by reference, wherein the pigment material (“PR149”) coated MCTS substrates are mounted on a drum that is then rotated so as to pass the substrate over single or sequential DC magnetron sputtering targets, each having a desired elemental composition. In these examples this catalyst layer was deposited from a single alloy target with a composition of Pt₇₅Co₂₂Mn₃ and a Pt loading of 0.05 mg/cm².

Comparative examples were prepared by fabricating full CCM's without applying any further catalyst onto the outer surface of the CCM.

### General Method for Testing CCM's

CCM's fabricated as described above were then tested in H₂/Air fuel cells. The full CCM's were installed with appropriate gas diffusion layers (GDL's) to make full MEA's directly into a 50 cm² test cell (obtained from Fuel Cell Technologies, Albuquerque, N. Mex.), with quad serpentine flow fields. The H₂ and air flow rates, pressures, relative humidity, and cell temperatures were then controlled under voltage (Potentiodynamic or potentiostatic) or current (galvanodynamic or galvanostatic) load control to break-in condition the MEA's and obtain polarization curves using test protocols well known to those skilled in the art. Properties of the catalyst cathodes were also measured using test protocols known to those skilled in the art for obtaining the absolute, area-specific and mass-specific activity at 900 mV for the oxygen reduction reaction (ORR), the surface area enhancement ratio of the electrodes (SEF), and the potentiodynamic current density at 0.813 volts under hydrogen air.

For the CCM's tested, the anode catalyst used was from a single lot of roll-coated catalyst of Pt₆₈Co₂₉Mn₃ having 0.05 mgPt/cm² loading. The membrane used was from the same lot number and the anode and cathode GDL's were from the same lot numbers. All samples were tested on the same test station in the same test cell. For those skilled in the art, these factors are known to potentially influence fuel cell performance. Fuel cell testing included start-up conditioning, fast potentiodynamic scans (PDS curves), slow galvanodynamic scans (HCT curves), ORR activity at 900 mV under oxygen, H_{upd} surface area, steady state performance under a range of temperatures and relative humidity's, and transient power-up (0.02-1 A/cm² step) under various temperatures and relative humidity's.

### Examples 1-7 and Comparative Examples A-D

Samples for Examples 1-7 and Comparative Examples A-D were prepared according to the general processes described above for General Method for Preparing Nanostructured Catalyst Support. Comparative Example D support was annealed at 3 foot/minute (about 0.9 meters/minute) rate. The initial thickness of the pigment material (“PR149”) coating was varied as summarized in Table 1 (below). Then, the first side of the nanostructured catalyst supports comprising the whiskers (i.e., NSTF whiskers) were coated with nanoscopic catalyst layer as described above under General Method for Coating Nanoscopic catalyst layers on nanostructured catalyst support whiskers (Nanostructured Thin Film (NSTF)). For all of Examples 1-7 and Comparative Examples A-D, the same amount of Pt containing catalyst (i.e., 0.10 mg-Pt/cm² of the PtCoMn ternary having the nominal composition of Pt₆₈Co₂₉Mn₃ in atomic percents) was deposited onto the whiskers. Next, the catalyst coated substrates were transferred onto one side of a 20 micrometer thick PEM (commercially available from 3M Company. St. Paul, Minn.) as described above forming CCMs for each of Examples 1-7 and Comparative Examples A-D. For the CCM's, the anode catalyst used was from a single lot of roll-coated catalyst of Pt₆₈Co₂₉Mn₃ having 0.05 mgPt/cm² loading. No further nanoscopic catalyst layers were added to Comparative Examples A-D CCMs. Examples 1-7 CCMs were coated with an additional layer of nanoscopic catalyst layer on the cathode side. For all of Examples 1-7 samples, the second nanoscopic catalyst layer was deposited (on the cathode side) from a single alloy target with a composition of Pt₇₅Co₂₂Mn₃ and a Pt loading of 0.05 mg/cm². The Examples 1-7 and Comparative Examples A-D CCMs were then tested by using the methods described above for testing CCMs. Certain details on Examples 1-7 and Comparative Examples A-D are provided in Table 1, below.

TABLE 1

| | Initial Thickness of | Amount of cathode | |
|---|---|---|---|
| | pigment material | catalyst (Pt₆₈Co₂₉Mn₃) | Amount of cathode |
| | (“PR149”) | on NSTF whiskers | catalyst (Pt₆₈Co₂₉Mn₃) |
| Example | (Angstroms) | (mgPt/cm²) | on CCM (mgPt/cm²) |
| 1 | 7200 | 0.10 | 0.05 |
| 2 | 7200 | 0.10 | 0.05 |
| 3 | 7200 | 0.10 | 0.05 |
| Comparative A | 7200 | 0.10 | None |
| 4 | 3600 | 0.10 | 0.05 |
| 5 | 3600 | 0.10 | 0.05 |
| Comparative B, 1^{st} | 3600 | 0.10 | None |
| Comparative B, 2^{nd} | 3600 | 0.10 | None |
| 6 | 2400 | 0.10 | 0.05 |
| 7 | 2400 | 0.10 | 0.05 |
| Comparative C, 1^{st} | 2400 | 0.10 | None |
| Comparative C, 2^{nd} | 2400 | 0.10 | None |
| Comparative D | 2200 | 0.15 | None |

Table 2(below) summarizes various test data for Examples 1-7 and Comparative Examples A-D including potentiodynamic current density at 0.813 volts under hydrogen/air (PDS), the surface area enhancement ratio of the electrodes (SEF), absolute, area-specific and mass-specific activity at 900 mV for the oxygen reduction reaction (ORR).

TABLE 2

| | PDS | | | | |
|---|---|---|---|---|---|
| | 0.813 V J | SEF (cm²- | ORR Absolute | ORR Specific | ORR Mass |
| | (A/cm²- | Pt/cm²- | Activity | Activity | Activity |
| Example | planar) | planar) | (mA/cm²-planar) | (mA/cm²-Pt) | (A/mg) |
| 1 | 0.148379 | 8.638578 | 16.68 | 1.931214 | 0.11122 |
| 2 | 0.146446 | 7.505826 | 13.62 | 1.813974 | 0.136154 |
| 3 | 0.161999 | 10.32909 | 18.06 | 1.748901 | 0.12043 |
| Comp. A | 0.128956 | 7.667729 | 13.79 | 1.797863 | 0.137855 |
| 4 | 0.18883 | 12.67828 | 27.28 | 2.152041 | 0.181895 |
| 5 | 0.203391 | 11.98271 | 25.41 | 2.120139 | 0.169367 |
| Comp. B1 | 0.177995 | 8.791349 | 16.50 | 1.876322 | 0.164954 |
| Comp. B2 | 0.198866 | 9.679381 | 12.93 | 1.335929 | 0.12931 |
| 6 | 0.208824 | 12.93 | 29.37 | 2.271 | 0.195786 |
| 7 | 0.210219 | 12.67253 | 30.35 | 2.394552 | 0.2023 |
| Comp. C1 | 0.181315 | 9.353132 | 19.00 | 2.031507 | 0.190009 |
| Comp. C2 | 0.182027 | 9.232591 | 19.44 | 2.105375 | 0.194381 |
| Comp. D | 0.182158 | 11.71595 | 23.96 | 2.04522 | 0.159745 |

Table 2 (above) shows that for each example type, the potentiodynamic polarization scan kinetic current density J at 0.813 volt exceeded the corresponding Comparative Example. That is, Examples 1, 2 and 3 showed more kinetic current density at 0.813 volts than Comparative Example A; Examples 4 and 5 on average showed more kinetic current density than Comparative Examples B on average; Examples 6 and 7 showed more kinetic current density than Comparative Examples C, and even more than Comparative Example D which had approximately the same amount of starting pigment material (“PR149”) thickness, the same total amount of Pt but no second nanoscopic catalyst layer.

Table 2 (above) also shows that for each example type, the Pt surface area was improved by forming the second nanoscopic electrocatalyst layer. That is, Examples 1, 2, and 3 showed higher SEF on average than Comparative Example A, Examples 4 and 5 showed higher SEF than Comparative Examples B, and Examples 6 and 7 showed higher SEF than Comparative Examples C, and even higher SEF than Comparative Example D which had approximately the same amount of starting pigment material (“PR149”) thickness, the same total amount of Pt but no second nanoscopic catalyst layer.

Table 2 (above) also shows that for each example type, the absolute ORR activity at 900 mV was improved by forming the second nanoscopic electrocatalyst layer. That is, Examples 1, 2, and 3 showed higher absolute activity on average than Comparative Example A; Examples 4 and 5 showed higher absolute activity than Comparative Examples B; and Examples 6 and 7 showed higher absolute activity than Comparative Examples C, and even higher absolute activity than Comparative Example D which had approximately the same amount of starting pigment material (“PR149”) thickness, the same total amount of Pt but no second nanoscopic catalyst layer.

Table 2 (above) also shows that for each example type, the area-specific ORR activity at 900 mV was improved by forming the second nanoscopic electrocatalyst layer. That is, Examples 1, 2, and 3 showed higher area-specific activity on average than Comparative Example A; Examples 4 and 5 showed higher area-specific activity than Comparative Examples B; and Examples 6 and 7 showed higher area-specific activity than Comparative Examples C, and even higher area-specific activity than Comparative Example D which had approximately the same amount of starting pigment material (“PR149”) thickness, the same total amount of Pt but no second nanoscopic catalyst layer.

Finally, Table 2 (above) shows that the mass-specific ORR activity at 900 mV of Examples 6 and 7 was higher on average than that of Comparative Examples C, and substantially higher than Comparative Example D which had approximately the same amount of starting pigment material (“PR149”) thickness, the same total amount of Pt but no second nanoscopic catalyst layer.

FIG. 4 is the potentiodynamic curves (PDS) for Examples 1-7 and Comparative Examples A-D acquired from 50 cm² MEA's under conditions of 75° C. cell temperature, 70° C. dew points, ambient outlet pressure of hydrogen and air and constant flow rates of 800/1800 sccm for the anode and cathode respectively. The constant voltage polarization scans were taken from 0.85 V to 0.25 V and back to 0.85 V in incremental steps of 0.05 V and a dwell time of 10 seconds per step.

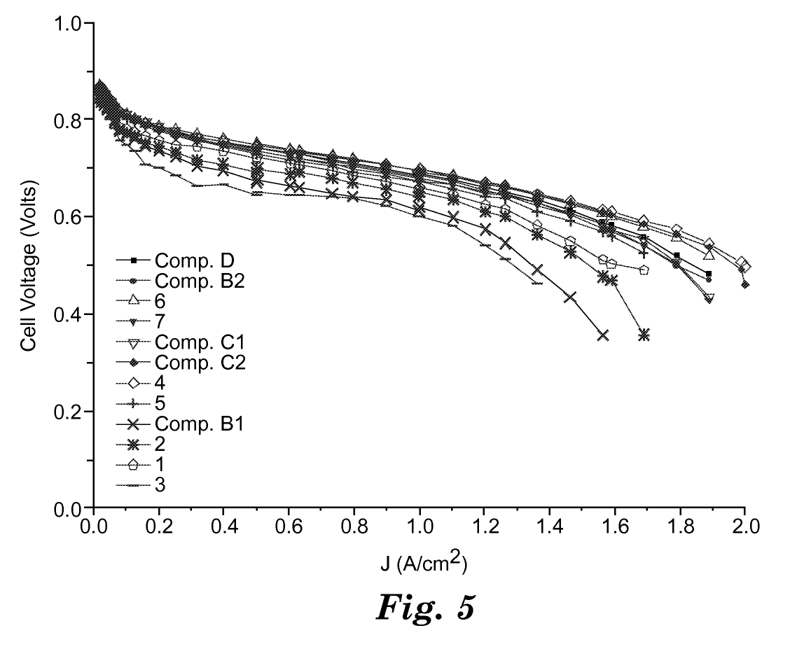

FIG. 5 is the galvanodynamic curves (GDS) for Examples 1-7 and Comparative Examples A-D acquired from 50 cm² MEA's under conditions of: 80° C. cell temperature, 68° C. dew points, 150 kPa absolute outlet pressure of hydrogen and air, stoichiometric flow rates of H₂/air on the anode and cathode respectively of 2/2.5. The constant current polarization scans were taken from 2.0 A/cm² to 0.02 A/cm² in incremental steps of 10 current steps per decade and a dwell time of 120 seconds per step. FIG. 5 shows that Examples 6 and 7 have the best hot/dry performance under galvanodynamic scan fuel cell testing.

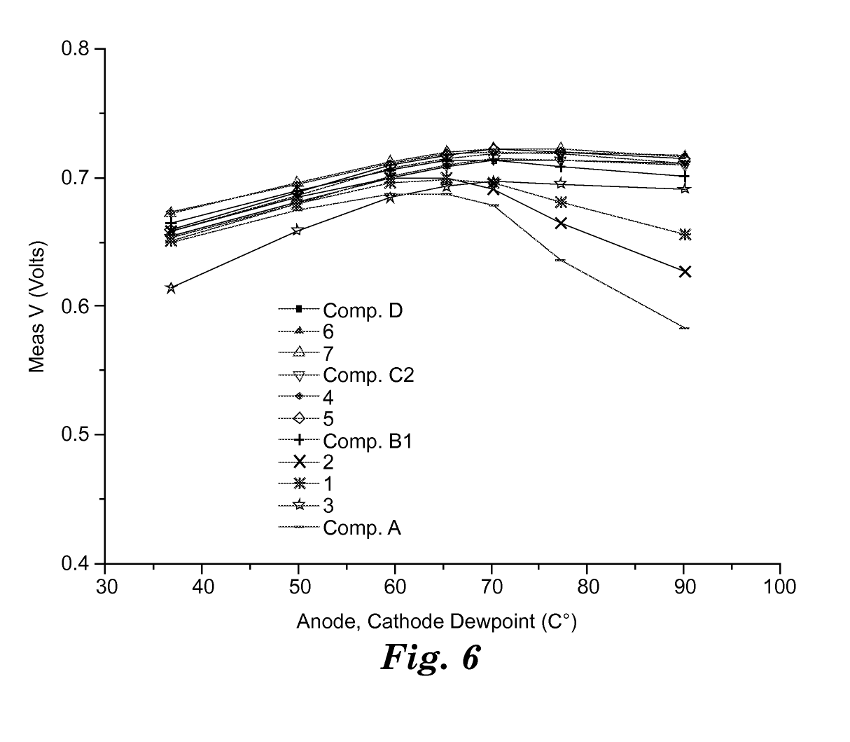

FIG. 6 is the galvanodynamic cell voltage response as a function of relative humidity at 90° C. for Examples 1-7 and Comparative Examples A-D.

Foreseeable modifications and alterations of this disclosure will be apparent to those skilled in the art without departing from the scope and spirit of this invention. This invention should not be restricted to the embodiments that are set forth in this application for illustrative purposes.

1. An electrochemical cell electrode comprising a nanostructured catalyst support layer having first and second generally opposed major sides, wherein the first side comprises nanostructured elements comprising support whiskers projecting away from the first side, the support whiskers having a first nanoscopic electrocatalyst layer thereon, and the a second nanoscopic electrocatalyst layer on the second side comprising precious metal alloy, wherein the precious metal alloy on the second major surface comprises at least one metal transition metal.

2. The electrochemical cell electrode of claim 1, wherein the precious metal of the second nanoscopic electrocatalyst layer is at least one of Pt, Ir, Au, Os, Re, Pd, Rh, or Ru.

3. (canceled)

4. The electrochemical cell electrode of claim 1, wherein the at least one metal transition metal is at least one of Ni, Co, Ti, Mn, or Fe.

5. The electrochemical cell electrode of claim 1, wherein the support layer has an average thickness in a range from 0.3 micrometer to 2 micrometer.

6. The electrochemical cell electrode of claim 1, wherein the whiskers have an average cross-sectional dimension in a range from 20 nm to 60 nm and an average length in a range from 0.3 micrometer to 3 micrometers.

7. The electrochemical cell electrode of claim 1, wherein the first and second nanoscopic electrocatalyst layers independently have an average planar equivalent thickness in a range from 0.1 nm to 50 nm.

8. The electrochemical cell electrode of claim 1, wherein the nanostructured elements comprise a first material, and wherein the second side having the second nanoscopic electrocatalyst layer thereon also comprises the first material.

9. The electrochemical cell electrode of claim 8, wherein the first material on the second side has a thickness in a range from 10 nm to 200 nm.

10. The electrochemical cell electrode of claim 8 having a first Pt surface area on the first side greater than zero for an oxygen reduction reaction, wherein the first and second nanoscopic electrocatalyst layers each comprise Pt and have a collective Pt content, wherein the collective Pt content if present just on the first side would have a second Pt surface area greater than zero for an oxygen reduction reaction, and wherein the Pt first surface area is at least 10 percent greater than the second Pt surface area.

11. The electrochemical cell electrode of claim 8 having a first Pt specific activity on the first side greater than zero for an oxygen reduction reaction, wherein the first and second nanoscopic electrocatalyst layers each comprise Pt and have a collective Pt content, wherein the collective Pt content if just present on the first side would have a second Pt specific activity greater than zero for an oxygen reduction reaction, and wherein the Pt first specific activity is at least 10 percent greater than the second Pt specific activity.

12. The electrochemical cell electrode of claim 8, wherein the first nanoscopic electrocatalyst layer has a first absolute activity greater than zero for an oxygen reduction reaction, wherein the second nanoscopic electrocatalyst layer has a second absolute activity greater than zero for an oxygen reduction reaction, and wherein the first absolute activity is at least 10 percent greater than the second absolute activity.

13. The electrochemical cell electrode of claim 8, wherein the first nanoscopic electrocatalyst layer has a first Pt content greater than zero for an oxygen reduction reaction and a first Pt surface area greater than zero, wherein the second nanoscopic electrocatalyst layer has a second Pt content and a second Pt surface area greater than zero for an oxygen reduction reaction, wherein the sum of the first and second Pt surface areas is at least 10 percent greater than the second Pt surface area.

14. The electrochemical cell electrode of claim wherein the first nanoscopic electrocatalyst layer has a first Pt content greater than zero for an oxygen reduction reaction and a first Pt specific activity greater than zero, wherein the second nanoscopic electrocatalyst layer has a second Pt content and a second Pt specific activity greater than zero for an oxygen reduction reaction, wherein the sum of the first and second Pt specific activities is at least 10 percent greater than the second Pt specific activity.

15. The electrochemical cell electrode of claim 1 that is a fuel cell catalyst electrode.

16. A method of making an electrochemical cell electrode of claim 1, the method comprising:
providing a nanostructured catalyst support layer having first and second generally opposed major sides, wherein the first side comprises nanostructured elements comprising support whiskers projecting away from the first side, the support whiskers having a first nanoscopic electrocatalyst layer thereon; and
sputtering a precious metal alloy onto the second side to provide a second nanoscopic electrocatalyst layer thereon.
